(19) United States
(12) Patent Application Publication
(10) Pub. No.: US 2023/0281544 A1
(43) Pub. Date: Sep. 7, 2023

(54) OIL AND GAS PRODUCTION-ORIENTED INTELLIGENT DECISION-MAKING SYSTEM AND METHOD

(71) Applicants: Beijing Sanotech Co., Ltd, Beijing (CN); University of Science & Technology Beijing, Beijing (CN)

(72) Inventors: Hongqing SONG, Beijing (CN); Jiulong WANG, Beijing (CN); Shuyi DU, Beijing (CN); Ming YUE, Beijing (CN)

(21) Appl. No.: 17/971,159

(22) Filed: Oct. 21, 2022

(30) Foreign Application Priority Data
Mar. 3, 2022 (CN) 202210209642.7

(51) Int. Cl. G06Q 10/06; G06Q 50/02

(52) U.S. Cl. CPC G06Q 10/067; G06Q 50/02

(57) ABSTRACT

The present disclosure provides an oil and gas production-oriented intelligent decision-making system and method. The system includes an oil-and-gas multi-source heterogeneous data management module configured to realize integrated data management in an oil and gas field; an oil and gas production-oriented intelligent decision-making module configured to realize oil and gas production-oriented intelligent decision-making, intelligent storage, gathering and transportation, intelligent operation and sales, as well as system management and maintenance; an intelligence algorithm component library configured to provide basic algorithms and intelligence algorithms customized based on a specific scenario; a containerization encapsulation and automatic management module configured to perform containerization encapsulation and unified container scheduling and management on oil-and-gas multi-source heterogeneous data, the intelligence algorithm component library and an intelligent service component library; and a scenarios-oriented customized development module configured to build a specialized model for different scenarios.

### CROSS REFERENCE TO RELATED APPLICATION

This patent application claims the benefit and priority of Chinese Patent Application No. 202210209642.7, filed on Mar. 3, 2022, the disclosure of which is incorporated by reference herein in its entirety as part of the present application.

### TECHNICAL FIELD

The present disclosure relates to the technical field of oil and gas development, and in particular to an oil and gas production-oriented intelligent decision-making system and method.

### BACKGROUND ART

The integration of big data and artificial intelligence (AI) with oil and gas industry not only marks a centerpiece in the new era for energy infrastructure, but also becomes an inevitable demand of the oil and gas enterprises for intelligent industrial upgrading. At present, traditional oil and gas enterprises have accumulated abundant data resources. However, they are faced with problems, such as a great variety of data, complicated structure, weak connection between data from different domains, and less development of practical application scenarios. Big data technology enables procedural processing and rapid extraction of massive oil and gas data, and in addition, AI algorithm allows for specialized integration and accurate mining on the data. Therefore, it is of great significance to innovate big data technology and AI technology in the oil and gas field, so as to develop an oil and gas production-oriented intelligent decision-making platform, form an ensemble framework featuring pipelined acquisition, integration, processing and fusion based on oil-and-gas multi-source heterogeneous data volumes, and establish multi-scenario production control and prediction technologies based on big data and AI, thereby realizing the digital and intelligent transformation of the oil and gas industry, and the cost decreasing and benefit increasing of oil and gas enterprises.

In the digital age, POSC, as a data and business model of oilfield data construction and information management system born in the IT era, has long been implemented in oilfield exploration and development in the oil industry to deal with the relationship between data and business operation.

However, in oilfield exploration and development, the existing IT architecture can no longer meet the production requirements, and is faced with many problems, such as a great variety of data, complicated structure, weak connection between data from different domains, and less development of practical application scenarios.

### SUMMARY

The present disclosure aims to provide an oil and gas production-oriented intelligent decision-making system and method, so as to resolve the problems that the existing IT architecture cannot meet the production demand, large amount of data but low quality, data processing is late and less accurate, and the requirement for an efficient production decision cannot be met.

To resolve the above technical problems, the present disclosure provides the following technical solutions:

In a first aspect, the present disclosure provides an oil and gas production-oriented intelligent decision-making system, the system including:
an oil-and-gas multi-source heterogeneous data management module configured to realize integrated data management in an oil and gas field;
an oil and gas production-oriented intelligent decision-making module configured to realize oil and gas production-oriented intelligent decision-making, intelligent storage, gathering and transportation, intelligent operation and sales, as well as system management and maintenance;
an intelligence algorithm component library configured to provide basic algorithms and intelligence algorithms customized based on a specific scenario;
a containerization encapsulation and automatic management module configured to perform containerization encapsulation and unified container scheduling and management on oil-and-gas multi-source heterogeneous data, the intelligence algorithm component library and an intelligent service component library; and
a scenarios-oriented customized development module configured to build a specialized model for different scenarios.

In an optional embodiment, the oil and gas production-oriented intelligent decision-making module includes:
a device layer configured to provide various infrastructure resource services of network transport, cloud computing, cloud storage, a general-purpose big data processing environment, a high-performance computing grid, artificial intelligence (AI) computing and data services;
an environmental support layer configured to provide environmental support for the processing of massive oil-and-gas multi-source heterogeneous data volumes;
a data center layer including a data acquisition unit, a data processing unit and a data computing unit;
a micro-service application layer configured to implement applications in various scenarios based on a micro-service technology; and
a user layer configured to realize the use of a system micro-service function and oil and gas data by different users.

In an optional embodiment, the oil-and-gas multi-source heterogeneous data management module includes:
an original database configured to store oil-and-gas multi-source heterogeneous data;
an original data-based oil-and-gas big data resource pool configured to classify and package the stored oil-and-gas multi-source heterogeneous data;
a data processing unit configured to perform unified and standardized processing on original data according to existing data standards and custom standards in an oil and gas industry; and
a data service unit configured to directly extract data in the original database, and open a data service channel to the outside, thereby enabling the system to quickly invoke the data from the original database as needed.

In an optional embodiment, the oil and gas production-oriented intelligent decision-making module includes:
an intelligent production decision-making unit in upstream oil and gas operations configured to realize an integrated intelligence algorithm service from oilfield development, intelligent prediction, effect evaluation, parameter optimization and intelligent decision-making;
an intelligent storage, gathering and transportation unit in midstream oil and gas operations configured to provide service personnel and managers in midstream operations with dynamic information of oil and gas, thereby providing guidance in oil and gas storage and transportation;
an intelligent operation and sales unit in downstream oil and gas operations configured to perform intelligent prediction according to facility management, market price analysis, market supply and demand, and user conditions in downstream oil and gas operations, thereby providing intelligent guidance in oil and gas trading; and
a system management and maintenance unit configured to control the authority of different users to operate each module in the system.

In an optional embodiment, the intelligence algorithm component library includes:
a basic algorithm library composed of machine learning and classical simulation algorithms, and
an intelligence algorithm library customized based on specific scenarios.

In an optional embodiment, the containerization encapsulation and automatic management module includes:
a distributed storage unit, a cache read-write unit, an interface authentication unit, a unified authentication unit, an access control unit, a service control unit, an equipment service unit, a user service unit and an analysis interface unit.

In an optional embodiment, the intelligent production decision-making unit in upstream oil and gas operations includes: an intelligent injection-production parameter optimization unit, an intelligent new well target decision-making unit, an intelligent logging interpretation analysis unit, an intelligent fracturing effect evaluation unit, an intelligent development performance control unit, an intelligent oil-and-gas production prediction unit, an intelligent oil-and-gas production calibration unit, and an intelligent reservoir property prediction unit.

In an optional embodiment, the intelligent storage, gathering and transportation unit in midstream oil and gas operations includes a liquefied natural gas (LNG) storage management unit, an LNG receiving station management unit, an LNG factory management unit, and a natural gas pipeline transportation unit.

In an optional embodiment, the intelligent operation and sales unit in downstream oil and gas operations includes: an intelligent natural gas facility management unit, an intelligent market price analysis unit, an intelligent market supply and demand predicting unit, an intelligent natural gas trade guidance unit, a natural gas user unit, and an underground gas storage management unit.

In a second aspect, the present disclosure provides an oil and gas production-oriented intelligent decision-making method, the method including:
performing, by an oil-and-gas multi-source heterogeneous data management module, unified and standardized processing, cleaning and supplementing, and correlative fusion on original data according to existing data standards and custom standards in an oil and gas industry;
based on expert knowledge, comprehensively sorting upstream, midstream and downstream oil and gas operations, analyzing data association in different scenarios, establishing a knowledge domains map of oil and gas data, and aggregating all the sorted operations to construct a business architecture;
integrating traditional numerical simulation methods and classical machine learning methods, building a customized machine learning model integrated with physical constraints according to different application scenarios, and performing, by an intelligence algorithm component library, intelligent computing according to specific data and specific business;
performing, by a containerization encapsulation and automatic management module, containerized encapsulation and unified container scheduling and management on oil-and-gas multi-source heterogeneous data, the intelligence algorithm component library and an intelligent service component library;
building, by a scenarios-oriented customized development module, specialized models for different scenarios according to results of intelligent computing; and
performing, by an oil and gas production-oriented intelligent decision-making module, oil and gas production-oriented intelligent decision-making, intelligent storage, gathering and transportation, intelligent operation and sales, as well as system management and maintenance.

The foregoing technical solutions provided in the embodiments of the present disclosure achieve the following beneficial effects:

According to the system provided in the embodiments of the present disclosure, an oil-and-gas multi-source heterogeneous data management module is configured to build an integrated framework featuring pipelined acquisition, integration, processing and fusion based on oil-and-gas multi-source heterogeneous data volumes, thereby realizing integrated data management in an oil and gas field with various types of data and complicated structures; an oil and gas production-oriented intelligent decision-making module realizes oil and gas production-oriented intelligent decision-making, intelligent storage, gathering and transportation, intelligent operation and sales, as well as system management and maintenance, thus strengthening the connection with industry knowledge; an intelligence algorithm component library integrates the multi-scenario production control and prediction technology based on big data and artificial intelligence, and forms a knowledge map of oil and gas data and a customized pattern featuring end-to-end no-code development of models in different scenarios, and meanwhile provides basic algorithms and intelligence algorithms customized based on specific scenarios; a containerization encapsulation and automatic management module configured to perform containerization encapsulation and unified container scheduling and management on oil-and-gas multi-source heterogeneous data, the intelligence algorithm component library and an intelligent service component library; and a scenarios-oriented customized development module configured to build a specialized model for different scenarios. In this way, the problems such as less correlation of business scenarios in the production of oil and gas industry are solved, and the oil and gas production-oriented intelligent decision-making is realized through the cooperation of the above modules. The system provided by the embodiments of the present disclosure plays an important role in the digital and intelligent development of the oil and gas industry, and achieves the purpose of cost decreasing and benefit increasing.

### BRIEF DESCRIPTION OF THE DRAWINGS

FIG. 1 shows a simple block diagram of an oil and gas production-oriented intelligent decision-making system;

FIG. 2 shows an overall block diagram of an oil and gas production-oriented intelligent decision-making system;

FIG. 3 is a flowchart illustrating oil-and-gas multi-source heterogeneous data management;

FIG. 4 is a structural schematic diagram of a knowledge domains map in a scenario of oil well plugging;

FIG. 5 shows an operational architecture diagram of an oil and gas production-oriented intelligent decision-making system;

FIG. 6 shows a schematic diagram for each operational module of an oil and gas production-oriented intelligent decision-making system;

FIG. 7 shows a schematic diagram of an artificial intelligence (AI) algorithm library, a classical model algorithm library and a fusion algorithm based on specific scenarios;

FIG. 8A-D show schematic diagrams of a module for each scenario of an oil and gas production-oriented intelligent decision-making system;

FIG. 9 shows a model building interface diagram of a custom algorithm editing module; and

FIG. 10 shows a visual model result display interface of a custom algorithm editing module.

### DETAILED DESCRIPTION OF THE EMBODIMENTS

To make the to-be-solved technical problems, technical solutions, and advantages of the present disclosure clearer, the present disclosure will be described in detail below with reference to the accompanying drawings and specific embodiments.

In the digital era, POSC, as a data and business model of oilfield data construction and information management system born in the IT era, has long been implemented in the exploration and development field of the oil industry to deal with the relationship between data and business operation. However, during oilfield exploration and development, the existing IT architecture can no longer meet the production requirements, and is faced with many problems, such as a great variety of data, complicated structure, weak connection between data from different domains, and less development of practical application scenarios. In view of the foregoing problems, the embodiments of the present disclosure provide an oil and gas production-oriented intelligent decision-making system and method, so as to solve above technical problem.

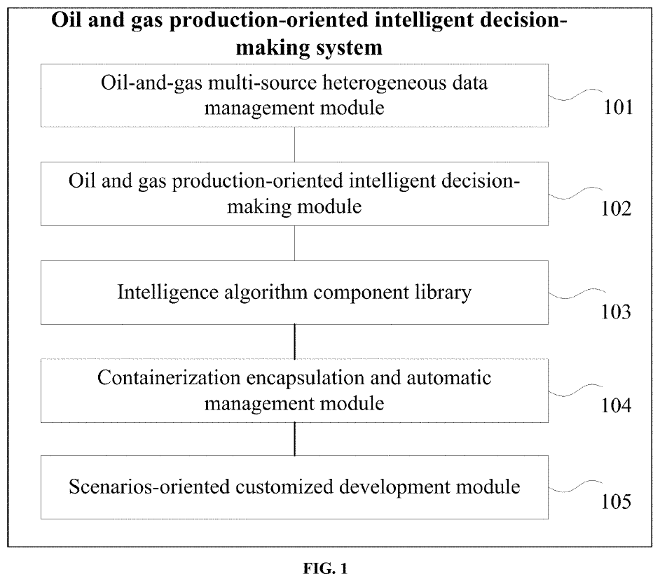

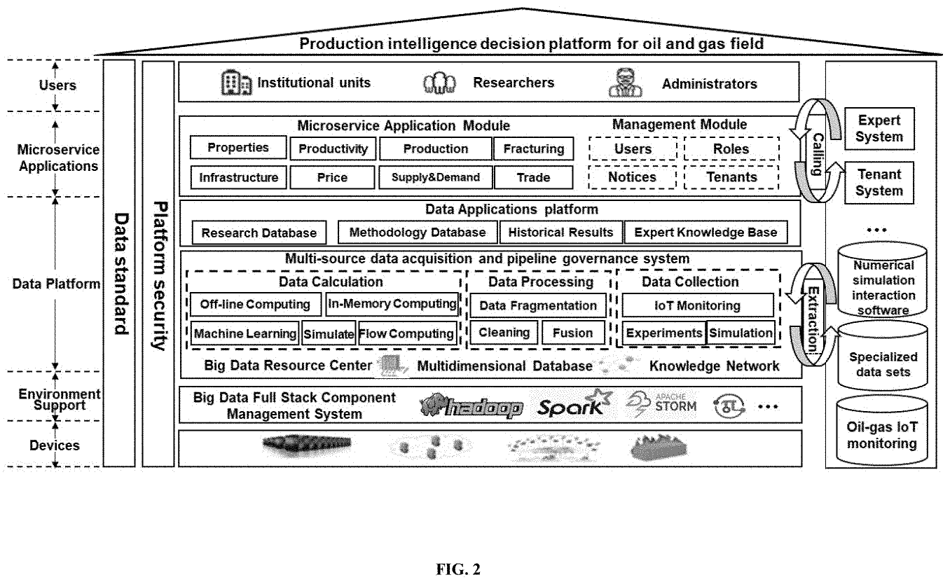

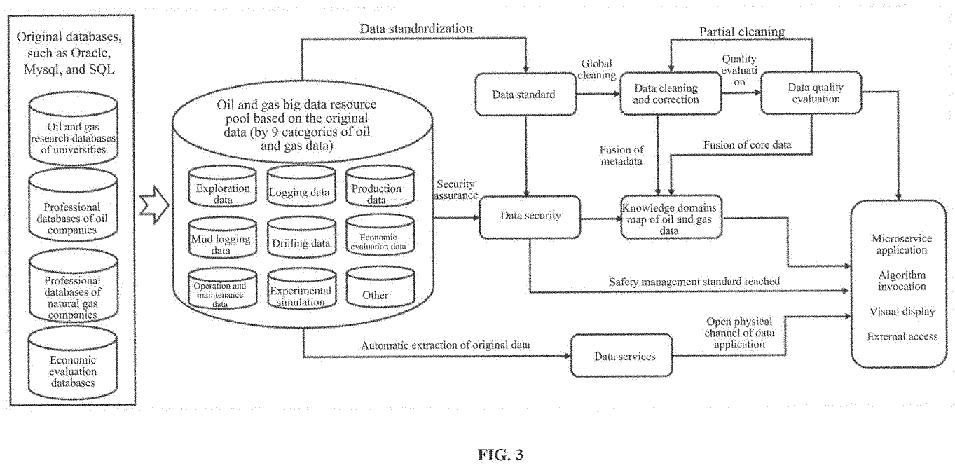

In a first aspect, referring to FIG. 1 and FIG. 2, the embodiments of the present disclosure provide an oil and gas production-oriented intelligent decision-making system, the system including:
an oil-and-gas multi-source heterogeneous data management module 101 configured to realize integrated data management in an oil and gas field;
an operational module 102 of an oil and gas production-oriented intelligent decision-making platform configured to realize oil and gas production-oriented intelligent decision-making, intelligent storage, gathering and transportation, intelligent operation and sales, as well as system management and maintenance;
an intelligence algorithm component library 103 configured to provide basic algorithms and intelligence algorithms customized based on a specific scenario;
a containerization encapsulation and automatic management module 104 configured to perform containerization encapsulation and unified container scheduling and management on oil-and-gas multi-source heterogeneous data, the intelligence algorithm component library 103 and an intelligent service component library; and
a customized development module 105 in different scenarios configured to build a specialized model for different scenarios.

The foregoing technical solutions provided in the embodiments of the present disclosure achieve the following beneficial effects:

According to the system provided in the embodiments of the present disclosure, the oil-and-gas multi-source heterogeneous data management module 101 is configured to build an ensemble framework featuring pipelined acquisition, integration, processing and fusion based on oil-and-gas multi-source heterogeneous data volumes, thereby realizing integrated data management in an oil and gas field with various types of data and complicated structures; the operational module 102 of an oil and gas production-oriented intelligent decision-making platform realizes oil and gas production-oriented intelligent decision-making, intelligent storage, gathering and transportation, intelligent operation and sales, as well as system management and maintenance, thus strengthening the connection with domain knowledge; the intelligence algorithm component library 103 integrates the multi-scenario production control and prediction technology based on big data and artificial intelligence (AI), and forms a knowledge map of oil and gas data and a customized pattern featuring end-to-end no-code development of models in different scenarios, and meanwhile provides basic algorithms and intelligence algorithms customized based on specific scenarios; the containerization encapsulation and automatic management module 104 configured to perform containerization encapsulation and unified container scheduling and management on oil-and-gas multi-source heterogeneous data, the intelligence algorithm component library 103 and an intelligent service component library; and the customized model development module 105 in different scenarios configured to build a specialized model for different scenarios. In this way, the problems such as less correlation of business scenario in the production of oil and gas industry are solved, and the oil and gas production-oriented intelligent decision-making is realized through the cooperation of the above modules. The system provided by the embodiments of the present disclosure plays an important role in the digital and intelligent development of the oil and gas industry, and achieves the purpose of cost decreasing and benefit increasing.

The system provided in the embodiments of the present disclosure is further illustrated and described by way of optional embodiments.

In an optional embodiment, the production-oriented intelligent decision-making module includes the following components.

A device layer is included and configured to provide various infrastructure resource services of network transport, cloud computing, cloud storage, a general-purpose big data processing environment, a high-performance computing grid, artificial intelligence computing and data services.

The device layer includes a China Science and Technology Cloud (CSTCloud) server, which meets such operating system environments as Windows, Linux, and Unix, and meanwhile provides various infrastructure resource services of network transport, cloud computing, cloud storage, a general-purpose big data processing environment, a high-performance computing grid, artificial intelligence computing and data services.

An environmental support layer is included and configured to provide environmental support for the processing of massive oil-and-gas multi-source heterogeneous data volumes.

The environmental support layer includes a big data full-stack component management system, which uses a hybrid computing framework of Apache Spark and Storm to construct an environmental support layer for processing massive oil-and-gas multi-source heterogeneous data volumes on the basis of Hadoop distributed storage, and in combination with data flow processing systems such as Piflow.

It should be noted that Hadoop is a distributed system architecture developed by Apache Software Foundation. It allows a user to develop distributed programs without knowing the underlying distribution. The advantages of clustering are made full use of for high-speed operation and storage.

A data center layer is configured, including a data acquisition unit, a data processing unit and a data computing unit.

It should be noted that the data center layer serves as the core of the oil and gas production-oriented intelligent decision-making system, including a data acquisition unit, a data processing unit and a data computing unit.

Further, data acquired by the data acquisition unit cover open knowledge data, which are obtained via professional oil-and-gas databases (Oracle, Mysql, SQL, etc.), oil-and-gas numerical simulation software (matlab, CMG, Eclipse, etc.) and Internet of things in the oil and gas industry (Scada, etc.); monitored experimental data, including structured data such as dynamic production data and seismic inversion data; and unstructured data, such as logging curves and digital core pictures, and semi-structural data such as seismic interpretation and logging reports, which forms oil-and-gas big data resource pool.

The data processing unit mainly carries out data cleaning and fusion on oil-and-gas multi-source heterogeneous data volumes, and cleans incomplete and abnormal data using partial cleaning, global cleaning and statistical methods. In addition, the data processing unit conducts correlative fusion on the clean data through the establishment of oil and gas-oriented professional knowledge map, thereby forming core research database, method base, results base and expert knowledge base.

Data computing mainly includes batch data processing based on MapReduce in Hadoop, Spark streaming, self-developed machine learning algorithm library and oil-and-gas numerical simulation method base, which can realize batch processing, stream processing and offline or real-time computing of massive oil and gas data.

A micro-service application layer is included and configured to implement applications in various scenarios based on a micro-service technology.

The micro-service application layer is an application module in various scenarios based on a micro-service technology.

In an optional embodiment, the micro-service application layer includes a production and development unit in upstream oil and gas operations, an intelligent storage, gathering and transportation unit in midstream oil and gas operations, an intelligent sales unit and a management unit in downstream oil and gas operations.

The production and development unit in upstream oil and gas operations includes application modules for reservoir property prediction, oil and gas productivity calibration, oil and gas production prediction, effect evaluation, so as to give targeted guidance for oilfield production and development, well logging and other aspects. The intelligent storage, gathering and transportation unit in midstream oil and gas operations includes modules for LNG storage management, LNG receiving station management, LNG factory management and intelligent operation and maintenance of natural gas pipelines, which provides service personnel and managers in midstream operations with effective guidance for oil and gas storage and transportation; the intelligent sales unit in downstream oil and gas operations includes modules for natural gas infrastructure management, market supply and demand prediction and price analysis, which is a specialized micro-service application for sales personnel and market analysts personnel in downstream oil and gas operations; and the management unit focuses on the system management and maintenance of the oil and gas production-oriented intelligent decision-making platform, which carries out customized management and authority distribution for different departments and personnel, including user management, role management, system announcement and tenant management. The micro-service application layer also has a special API service invocation interface, which is configured to connect oil and gas expert systems or tenant experience systems.

The user layer enables government personnel, researchers and managers to use micro-service functions of the platform and oil and gas data.

The user layer is configured to realize the use of a system micro-service function and oil and gas data by different users. Referring to FIG. 2, in an example, the user layer may include government personnel, researchers, managers, etc.

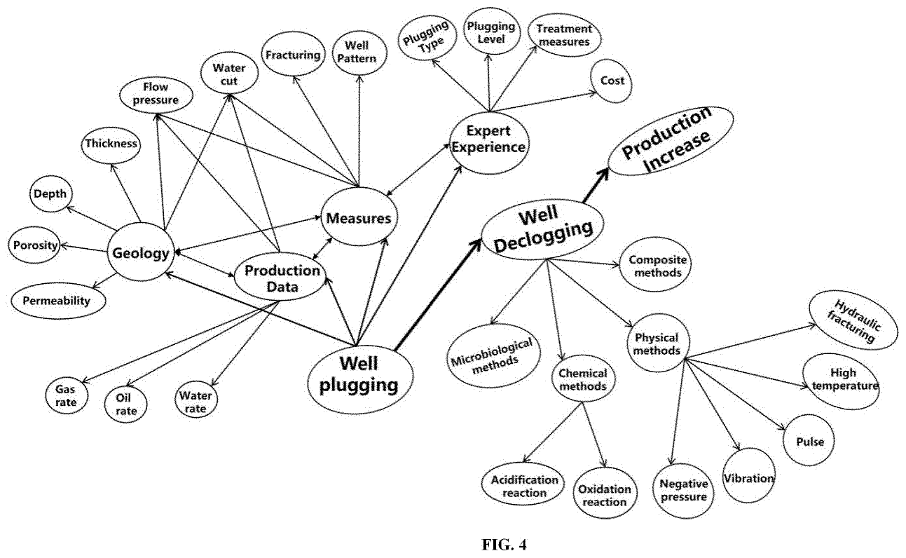

Referring to FIG. 3, in an optional embodiment, the oil-and-gas multi-source heterogeneous data management module 101 includes: an original database, configured to store oil-and-gas multi-source heterogeneous data.

The bottom layer of the oil and gas production-oriented decision-making platform is connected with original databases, including oil and gas research databases of universities, professional databases of oil companies, professional databases of natural gas companies, and economic evaluation databases, covering various types, such as Oracle, Mysql, and SQL.

An original data-based oil-and-gas big data resource pool is included and configured to classify and package the stored oil-and-gas multi-source heterogeneous data.

By classifying and packaging data from the original databases according to 9 categories, namely exploration, logging, mud logging, production, drilling, operation and maintenance, experimental simulation, economic evaluation, etc., the oil and gas big data resource pool based on the original data is formed, which break down the barriers between various institutions.

A data processing unit is included and configured to perform unified and standardized processing on original data according to existing data standards and custom standards in an oil and gas industry.

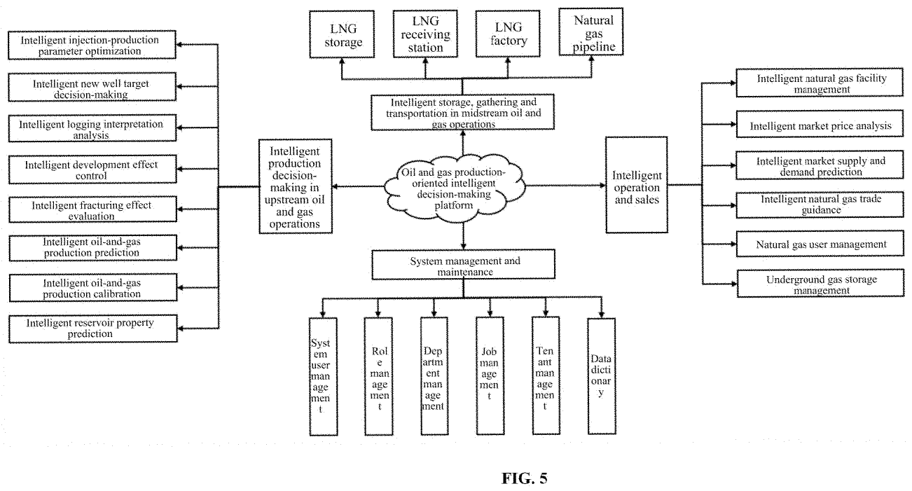

The data processing unit conducts unified and standardized processing on the original data according to the existing data standards and custom standards in the oil and gas industry, searches for problems of deficiency and abnormality in the data using a global cleaning algorithm, completes and denoises the data, and evaluates the cleaned data through their respective quality evaluation systems, where the unqualified data need to be cleaned again according to corresponding fields and data characteristics until they pass the data evaluation, which greatly improves data quality. Then, by taking the cleaned data entities as nodes and the relationship between entities as edges, as shown in FIG. 4, the knowledge domains map oriented to oil and gas field is constructed based on the experience and knowledge of experts, and a map database of oil and gas field is established.

A data service unit is included and configured to directly extract data in the original database, and open a data service channel to the outside, thereby enabling the system to quickly invoke the data from the original database as needed.

The data service unit can directly extract the data from the original database and open the data service channel to the outside, and each module in the application layer can quickly invoke the original data interface according to its own needs. Finally, the application layer includes micro-service applications, algorithm invoking, visualization services and external services, which can directly invoke the core data that pass the data quality evaluation, the map database constructed according to the knowledge domains map of oil and gas data, and the original data-based oil-and-gas big data resource pool. The oil-and-gas multi-source heterogeneous data management module 101 realizes the integrated data management system featuring data acquisition, cleaning, extraction and fusion. For example, it may include the professional knowledge domains map for oil well plugging.

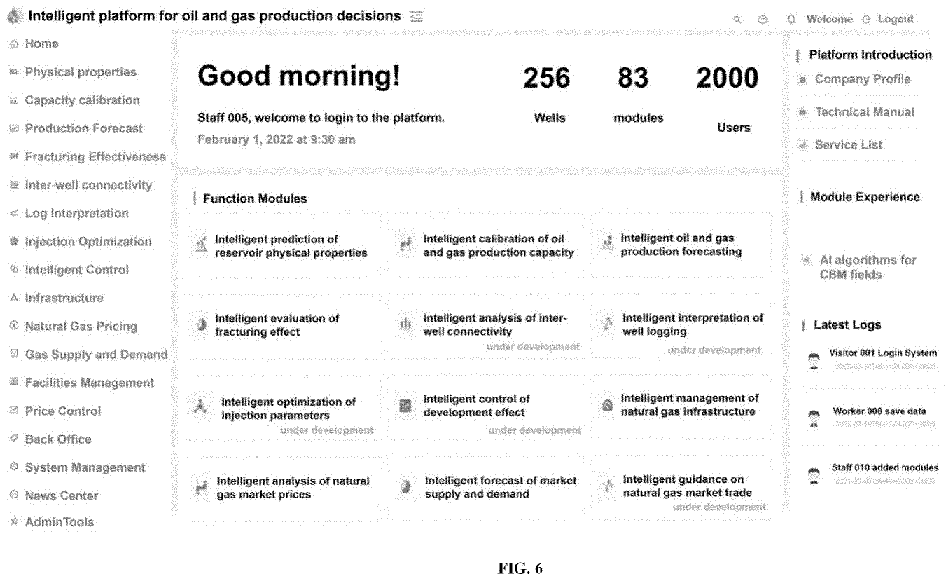

In an optional embodiment, as shown in FIG. 5 and FIG. 6, the operational module 102 of an oil and gas production-oriented intelligent decision-making platform includes:
an intelligent production decision-making unit in upstream oil and gas operations configured to realize an integrated intelligence algorithm service from oilfield development, intelligent prediction, effect evaluation, parameter optimization and intelligent decision-making.

In an optional embodiment, the intelligent production decision-making unit in upstream oil and gas operations includes: an intelligent injection-production parameter optimization unit, an intelligent new well target decision-making unit, an intelligent logging interpretation analysis unit, an intelligent fracturing effect evaluation unit, an intelligent development performance control unit, an intelligent oil-and-gas production prediction unit, an intelligent oil-and-gas production calibration unit, and an intelligent reservoir property prediction unit.

The intelligent production decision-making unit in upstream oil and gas operations mainly includes eight integrated algorithm modules, and each functional module includes intelligence algorithms and application examples corresponding to different scenarios, thereby forming an integrated intelligence algorithm service system covering oilfield development, intelligent prediction, effect evaluation, parameter optimization, and intelligent decision-making.

An intelligent storage, gathering and transportation unit in midstream oil and gas operations is included and configured to provide service personnel and managers in midstream operations with dynamic information of oil and gas, thereby providing guidance in oil and gas storage and transportation.

In an optional embodiment, the intelligent storage, gathering and transportation unit in midstream oil and gas operations includes an LNG storage management unit, an LNG receiving station management unit, an LNG factory management unit, and natural gas pipeline transportation unit. The intelligent storage, gathering and transportation unit in midstream oil and gas operations enables service personnel and managers in midstream operations to grasp the entire dynamic information of oil and gas in the process of collection, transportation and reception, thereby providing guidance in oil and gas storage and transportation.

An intelligent operation and sales unit in downstream oil and gas operations is included and configured to perform intelligent prediction according to facility management, market price analysis, market supply and demand, and user conditions in downstream oil and gas operations, thereby providing intelligent guidance in oil and gas trading.

In an optional embodiment, the intelligent operation and sales unit in downstream oil and gas operations includes: an intelligent natural gas facility management unit, an intelligent market price analysis unit, an intelligent market supply and demand predicting unit, an intelligent natural gas trade guidance unit, natural gas user unit, and an underground gas storage management unit.

The intelligent operation and sales unit in downstream oil and gas operations can understand the detailed data of petrol stations, natural gas stations, power plants and urban gas supply stations through natural gas infrastructure management, and can conduct intelligent market price analysis and intelligent market supply and demand prediction based on the basic data, thereby realizing intelligent natural gas trade guidance.

A system management and maintenance unit is included and configured to control the authority of different users to operate each module in the system.

The system management and maintenance unit mainly includes user management, role management, department management, job management, tenant management and data dictionary, and can control the authority of personnel from different departments or at different positions to operate each module of the oil and gas production-oriented intelligent decision-making system. Thus, upstream developers, downstream salespeople, system testers and system leasing personnel operate modules in their respective fields without interfering with each other.

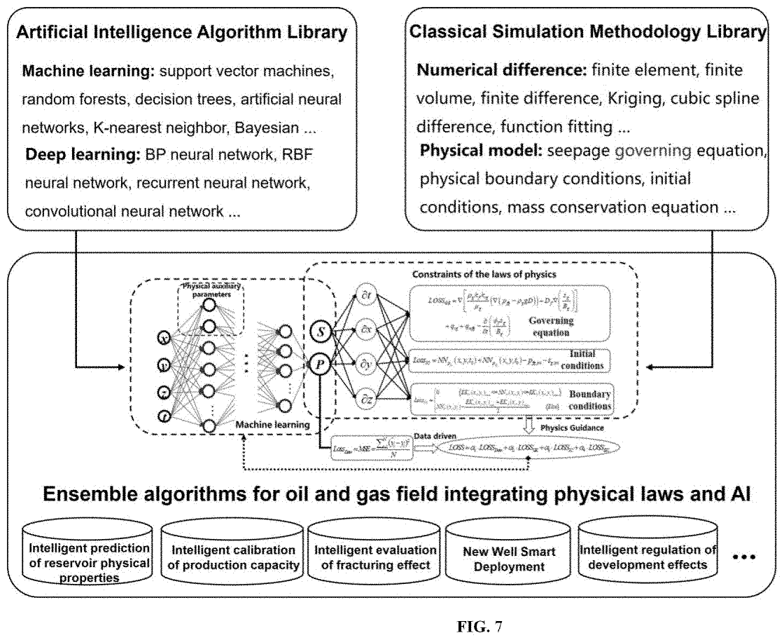

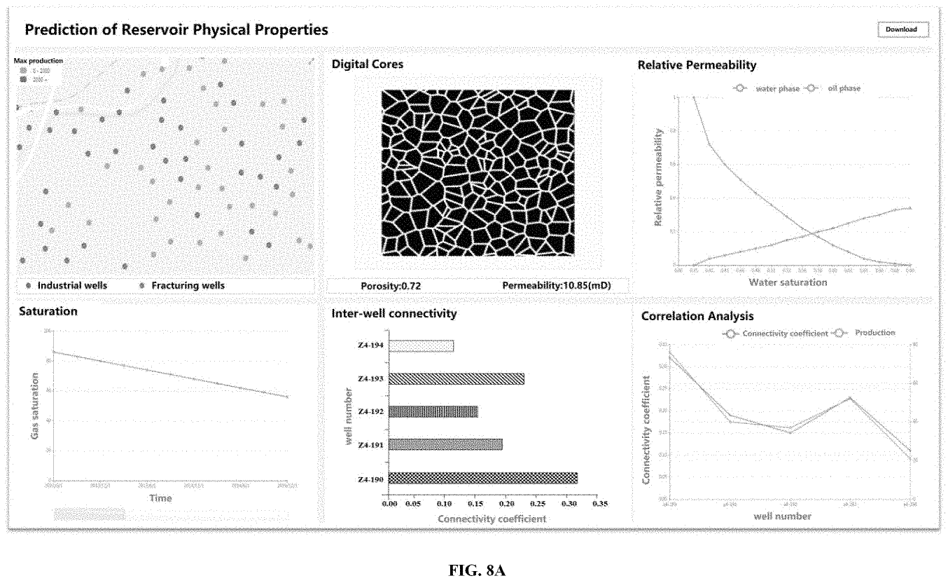

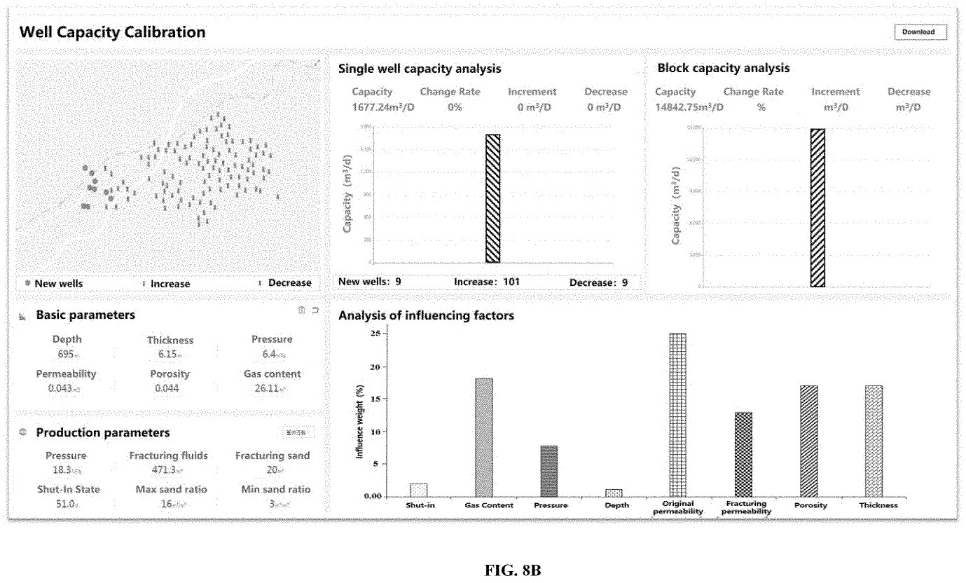

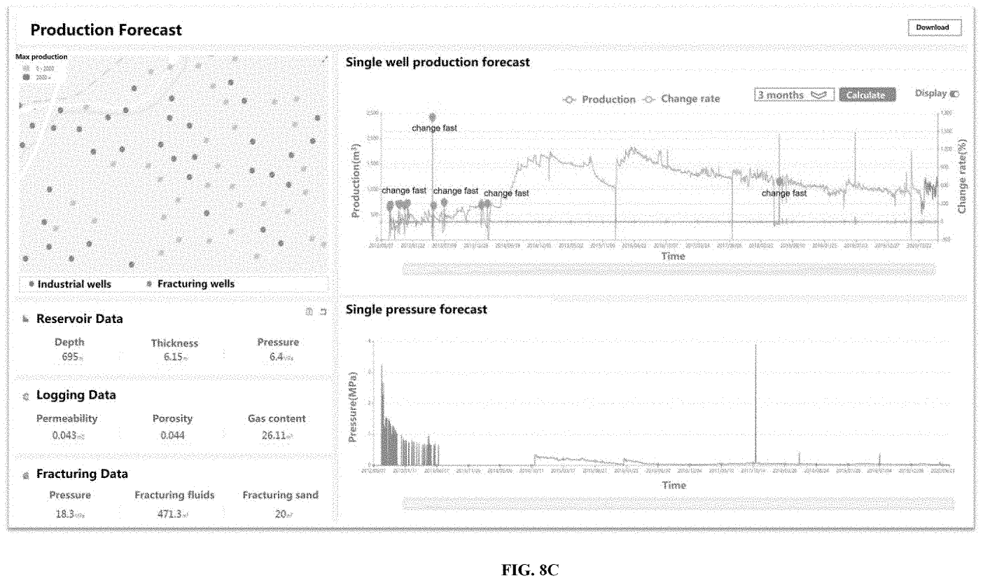

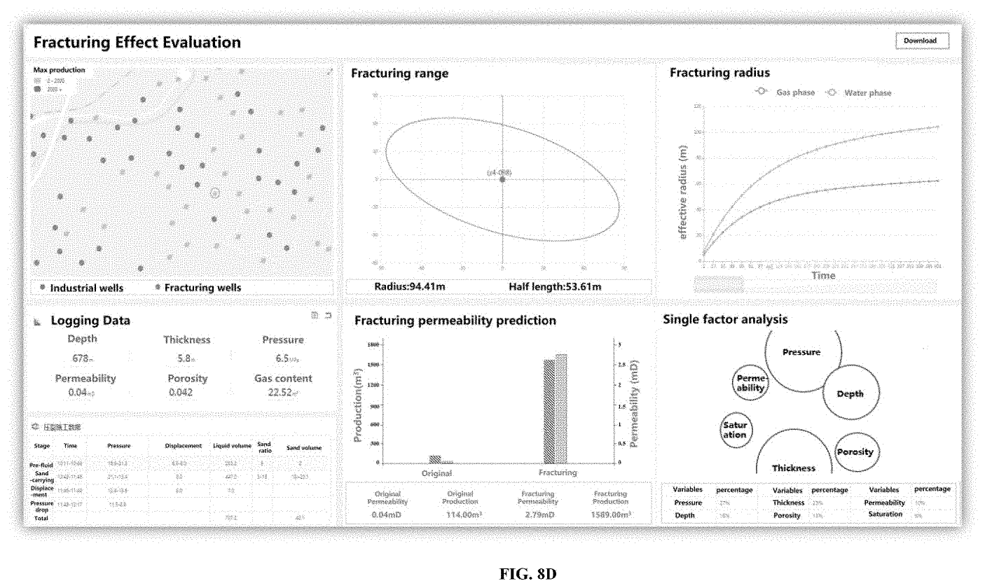

In an optional embodiment, the intelligence algorithm component library 103 includes:
a basic algorithm library composed of machine learning and classical simulation algorithms,
as shown in FIG. 7. The intelligence algorithm component library 103, as illustrated in an integrated algorithm diagram for physical laws and AI in the oil and gas field in FIG. 7, mainly includes two parts. One is the basic algorithm library composed of machine learning and classical simulation algorithms, where regarding the machine learning library, intelligence algorithms such as support vector machines, random forest, neural network, and Naive Bayes are directly invoked through skleam, keras, TensorFlow and other learning libraries based on Python environment; and based on matlab and Python languages, the classical algorithms such as finite element, finite difference and finite volume are developed independently, and meanwhile, the integrated algorithms can also be invoked, such as finite element, finite volume, finite difference, Kriging difference, cubic spline interpolation and function fitting. FIG. 8A-D show schematic diagrams of a module for each scenario of an oil gas production-oriented intelligent decision-making system.

An intelligence algorithm library is customized based on specific scenarios.

The core idea of the intelligence algorithm customized based on specific scenario is: on the basis of machine learning algorithms (support vector machine, random forest, decision-making tree, artificial neural network, Xgboost, K-nearest neighbor, Naive Bayes, etc.), the control equation, boundary conditions and initial conditions of the classical simulation algorithm, as constraints, are integrated into the machine learning algorithm in the form of constructing a new loss function. According to the development pattern of the foregoing algorithms, characteristic algorithms are established, such as algorithms for intelligent reservoir property prediction, intelligent oil-and-gas production calibration, and intelligent fracturing effect evaluation. In addition, considering the programming ability of personnel working in the oil and gas field, an end-to-end codeless operation platform is established to integrate and package the basic algorithms and customized algorithms into structured algorithm modules (in a format of H5, PTH, T7, PKL, MAT, etc.), which are invoked in a drag-and-drop manner, where at the front end, the algorithm event is triggered by clicking the drag-and-drop icon, and at the back end, a model is automatically built in response to the front end, thus realizing fast assembly and pipeline scheduling mode of the algorithm.

In an optional embodiment, the containerization encapsulation and automatic management module 104 includes:
a distributed storage unit, a cache read-write unit, an interface authentication unit, a unified authentication unit, an access control unit, a service control unit, an equipment service unit, a user service unit and an analysis interface unit.

Further, the containerization encapsulation and automatic management module 104 conducts containerization encapsulation on production and operation data, intelligence algorithms, and intelligent service component libraries by using Docker technology under the cloud-native architecture, with tasks covering distributed storage, cache read-and-write, interface authentication, unified authentication, access control, service control, device service, user service, analysis interface, etc., thus forming independent units deployed by application programs to achieve a high level of resource isolation; besides, the containerization encapsulation and automatic management module conducts unified container scheduling and management using Kubemetes technology under the cloud-native architecture, so as to organize containers into groups, and provide load balancing between containers, which makes it possible to expand or shrink the containers at any time; and rolling releasing is adopted to upgrade applications from one environment to another without downtime, thus forming cloud-native model management for distributed model output, reading and utilization. With the purpose of Function-as-a-Service (FaaS), and by using Distributed Application Runtime (Dapr) framework under the cloud-native architecture in a loose coupling manner, interface authentication, website authentication, access control, routing control, intelligence algorithm library, device service, knowledge service and model service are organized and separated according to business capabilities, so that codes can be updated more easily and scaled independently, thus realizing the rapid construction and coordinated invocation of micro-service applications.

In an optional embodiment, the customized development module 105 in different scenarios is configured to build a specialized model for different scenarios.

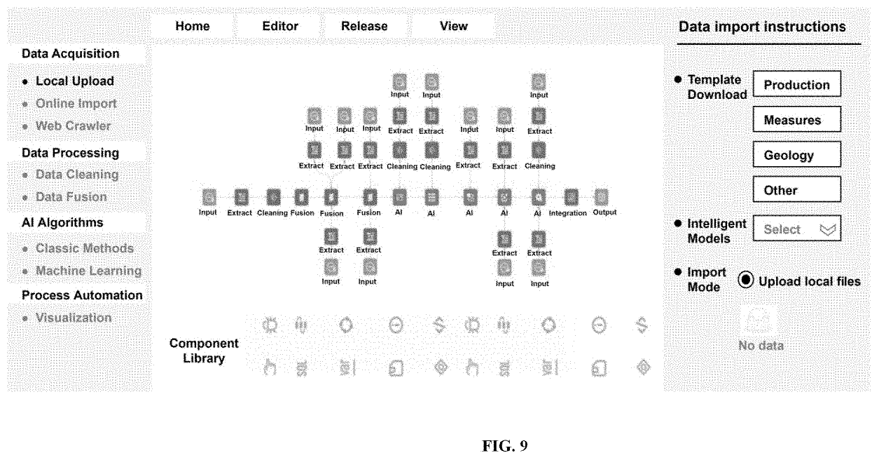

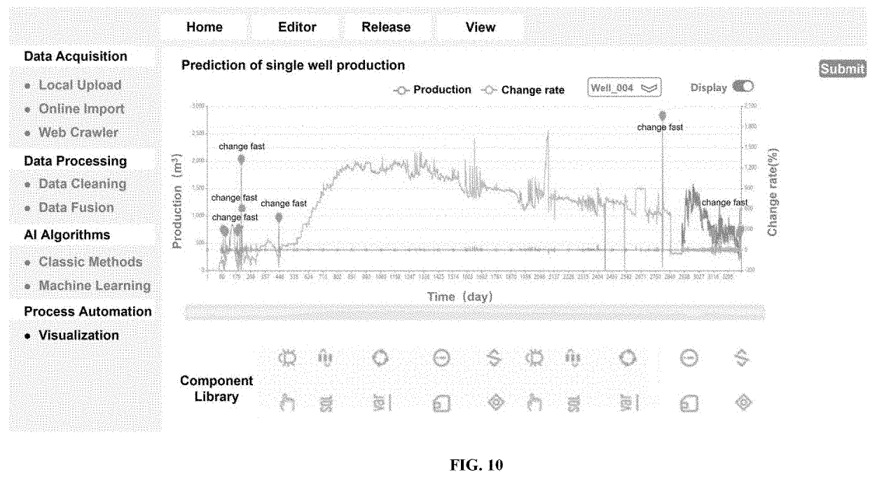

FIG. 9 shows a model building interface diagram of a custom algorithm editing module; and FIG. 10 shows a visual model result display interface of a custom algorithm editing module. After logging in to the platform, the user can obtain required data sets through local upload, online import and web crawler. The uploaded data will be temporarily saved in a background database and given specific tag codes. The oil and gas production-oriented intelligent decision-making system, considering the complexity of data and algorithms in the oil and gas industry, constructs a model editor and imports the required data into the editor. A corresponding data cleaning algorithm is selected to improve the data quality; based on the encapsulated algorithm component library, a specialized model for different scenarios is built by drag-and-drop, user is helped to establish a complex autonomous learning model in a graphical way, and a visualization technology makes it possible to display the output results and application results of the model, as shown in FIG. 10. Self-built models can also be subject to process-oriented packaging to facilitate the next one-button invoking. At the same time, these customized algorithm models have API interfaces, which can allow other software to invoke, and internal data can also be accessed through Url.

In a second aspect, the present disclosure provides an oil and gas production-oriented intelligent decision-making method, the method including:
performing, by an oil-and-gas multi-source heterogeneous data management module 101, unified and standardized processing, cleaning and supplementing, and correlative fusion on original data according to existing data standards and custom standards in an oil and gas industry;
based on expert knowledge, comprehensively sorting upstream, midstream and downstream oil and gas operations, analyzing data association in different scenarios, establishing a knowledge map of oil and gas data, and aggregating all the sorted operations to construct a business architecture;
integrating traditional numerical simulation methods and classical machine learning methods, building a customized machine learning model integrated with physical constraints according to different application scenarios, and performing, by an intelligence algorithm component library, intelligent computing according to specific data and specific business;
performing, by a containerization encapsulation and automatic management module 104, containerization encapsulation and unified container scheduling and management on oil-and-gas multi-source heterogeneous data, the intelligence algorithm component library and an intelligent service component library;
building, by a scenarios-oriented customized development module, a specialized model for different scenarios according to a result of intelligent computing; and
performing, by an oil and gas production-oriented intelligent decision-making module, oil and gas production-oriented intelligent decision-making, intelligent storage, gathering and transportation, intelligent operation and sales, as well as system management and maintenance.

The method provided by the embodiments of the present disclosure includes modules for production and development in upstream oil and gas operations, storage, gathering and transportation in midstream oil and gas operations, and production and sales in downstream operations, and can automatically process oil-and-gas multi-source heterogeneous data, thereby improving the work efficiency of managers and service personnel.

The present disclosure provides a management system for oil-and-gas multi-source and heterogeneous data, which can break industry barriers, efficiently integrate various databases from different institutions, and carry out data standardization, cleaning and fusion. Based on the specialist experience, the knowledge domains map of oil and gas data is established, the integrated data management system featuring data acquisition, cleaning, extraction and fusion is realized, which strengthens the fusion of industry knowledge.

The present disclosure provides a platform business architecture for the oil and gas field, which integrates the production module in upstream oil and gas operations, the transportation module in midstream oil and gas operations, the sales module and the system management module in downstream operations within the platform to form a complete one-stop service mode, thereby improving the decision-making ability of managers as a whole.

The present disclosure provides an intelligence algorithm component library 103 for the oil and gas field, which not only integrates machine learning algorithm and classical reservoir simulation algorithm into the basic algorithm library, but also deeply combines the two algorithms to form characteristic algorithms based on different scenarios. The characteristic algorithm component library in oil and gas field is constructed, which realizes codeless encapsulation and invoking mode, and further the modeling efficiency of researchers.

The present disclosure also provides the containerization encapsulation and automatic management mode of each module in the upstream, midstream and downstream oil and gas operations to display the containerization encapsulation and independent deployment for oil and gas data operation, intelligence algorithm invoke and characteristic algorithm, which realizes the rapid construction and coordinated invocation of micro-service applications, and improves the expansibility and portability of the application layer.

The self-defined model development mode is put forward, and the drag-and-drop flow model editor is formed by using the internal algorithm library of the platform and the knowledge domains map for the oil and gas data, which improves the work efficiency of developers.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. An oil and gas production-oriented intelligent decision-making system, comprising:
an oil-and-gas multi-source heterogeneous data management module configured to realize integrated data management in an oil and gas field;
an oil and gas production-oriented intelligent decision-making module configured to realize oil and gas production-oriented intelligent decision-making, intelligent storage, gathering and transportation, intelligent operation and sales, as well as system management and maintenance;
an intelligence algorithm component library configured to provide basic algorithms and intelligence algorithms customized based on a specific scenario;
a containerization encapsulation and automatic management module configured to perform containerization encapsulation and unified container scheduling and management on oil-and-gas multi-source heterogeneous data, the intelligence algorithm component library and an intelligent service component library; and
a scenarios-oriented customized development module configured to build a specialized model for different scenarios.

2. The oil and gas production-oriented intelligent decision-making system according to claim 1, wherein the oil and gas production-oriented intelligent decision-making module comprises:
a device layer configured to provide various infrastructure resource services of network transport, cloud computing, cloud storage, a general-purpose big data processing environment, a high-performance computing grid, artificial intelligence computing and data services;
an environmental support layer configured to provide environmental support for the processing of massive oil-and-gas multi-source heterogeneous data volumes;
a data center layer comprising a data acquisition unit, a data processing unit and a data computing unit;
a micro-service application layer configured to implement applications in various scenarios based on a micro-service technology; and
a user layer configured to realize the use of a system micro-service function and oil and gas data by different users.

3. The oil and gas production-oriented intelligent decision-making system according to claim 1, wherein the oil-and-gas multi-source heterogeneous data management module comprises:
an original database configured to store oil-and-gas multi-source heterogeneous data;
an original data-based oil-and-gas big data resource pool configured to classify and package the stored oil-and-gas multi-source heterogeneous data;
a data processing unit configured to perform unified and standardized processing on original data according to existing data standards and custom standards in an oil and gas industry; and
a data service unit configured to directly extract data in the original database, and open a data service channel to the outside, thereby enabling the system to quickly invoke the data from the original database as needed.

4. The oil and gas production-oriented intelligent decision-making system according to claim 1, wherein the oil and gas production-oriented intelligent decision-making module comprises:
an intelligent production decision-making unit in upstream oil and gas operations configured to realize an integrated intelligence algorithm service from oilfield development, intelligent prediction, effect evaluation, parameter optimization and intelligent decision-making;
an intelligent storage, gathering and transportation unit in midstream oil and gas operations configured to provide service personnel and managers in midstream operations with dynamic information of oil and gas, thereby providing guidance in oil and gas storage and transportation;
an intelligent operation and sales unit in downstream oil and gas operations configured to perform intelligent prediction according to facility management, market price analysis, market supply and demand, and user conditions in downstream oil and gas operations, thereby providing intelligent guidance in oil and gas trading; and
a system management and maintenance unit configured to control the authority of different users to operate each module in the system.

5. The oil and gas production-oriented intelligent decision-making system according to claim 1, wherein the intelligence algorithm component library comprises;
a basic algorithm library composed of machine learning and classical simulation algorithms, and
an intelligence algorithm library customized based on a specific scenario.

6. The oil and gas production-oriented intelligent decision-making system according to claim 1, wherein the containerization encapsulation and automatic management module comprises:
a distributed storage unit, a cache read-write unit, an interface authentication unit, a unified authentication unit, an access control unit, a service control unit, an equipment service unit, a user service unit and an analysis interface unit.

7. The oil and gas production-oriented intelligent decision-making system according to claim 4, wherein the intelligent production decision-making unit in upstream oil and gas operations comprises: an intelligent injection-production parameter optimization unit, an intelligent new well target decision-making unit, an intelligent logging interpretation analysis unit, an intelligent fracturing effect evaluation unit, an intelligent development performance regulation unit, an intelligent oil-and-gas production prediction unit, an intelligent oil-and-gas production calibration unit, and an intelligent reservoir property prediction unit.

8. The oil and gas production-oriented intelligent decision-making system according to claim 4, wherein the intelligent storage, gathering and transportation unit in midstream oil and gas operations comprises: a liquefied natural gas (LNG) storage management unit, an LNG receiving station management unit, an LNG factory management unit, and a natural gas pipeline transportation unit.

9. The oil and gas production-oriented intelligent decision-making system according to claim 4, wherein the intelligent operation and sales unit in downstream oil and gas operations comprises; an intelligent natural gas facility management unit, an intelligent market price analysis unit, an intelligent market supply and demand predicting unit, an intelligent natural gas trade guidance unit, a natural gas user unit, and an underground gas storage management unit.

10. An oil and gas production-oriented intelligent decision-making method, comprising:
performing, by an oil-and-gas multi-source heterogeneous data management module, unified and standardized processing, cleaning and supplementing, and correlative fusion on original data according to existing data standards and custom standards in an oil and gas industry;
based on expert knowledge, comprehensively sorting upstream, midstream and downstream oil and gas operations, analyzing data association in different scenarios, establishing a knowledge domains map of oil and gas data, and aggregating all the sorted operations to construct a business architecture;
integrating traditional numerical simulation methods and classical machine learning methods, building a customized machine learning model integrated with physical constraints according to different application scenarios, and performing, by an intelligence algorithm component library, intelligent computing according to specific data and specific business;
performing, by a containerization encapsulation and automatic management module, containerization encapsulation and unified container scheduling and management on oil-and-gas multi-source heterogeneous data, the intelligence algorithm component library and an intelligent service component library;
building, by a scenarios-oriented customized development module, a specialized model for different scenarios according to a result of intelligent computing; and
performing, by an oil and gas production-oriented intelligent decision-making module, oil and gas production-oriented intelligent decision-making, intelligent storage, gathering and transportation, intelligent operation and sales, as well as system management and maintenance.
